(19) United States
(12) Patent Application Publication
(10) Pub. No.: US 2009/0321970 A1
(43) Pub. Date: Dec. 31, 2009

(54) OPHTHALMIC LENS MOLDS PARTS WITH SILOXANE WAX

(76) Inventors: Changhong Yin, St. Augustine, FL (US); Scott F. Ansell, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/437,909

(22) Filed: May 8, 2009

Related U.S. Application Data
(60) Provisional application No. 61/076,815, filed on Jun. 30, 2008.

(51) Int. Cl. G02B 1/12; G02B 3/00; C08K 5/5415; G02C 7/04

(52) U.S. Cl. 264/1.36; 264/1.1; 524/269; 351/160 R

(57) ABSTRACT

This invention discloses improved mold parts for ophthalmic lenses fashioned from a thermal plastic resin compounded with a siloxane wax resulting in a thermal plastic compound with a deionized water contact angle that is greater than the deionized water contact angle of the pure thermal plastic resin. The mold parts can be used in manufacturing processes, such as, for example: continuous, in-line or batched processes.

### RELATED PATENT APPLICATIONS

This patent application claims priority to a provisional application U.S. Ser. No. 61/076,815, which was filed on Jun. 30, 2008.

### FIELD OF USE

This invention describes ophthalmic lens molds with siloxane wax and ophthalmic lenses formed with the molds.

### BACKGROUND

Soft contact lenses are popular and often more comfortable to wear than contact lenses made of hard materials. Malleable contact lenses made of silicone based hydrogels can be manufactured by forming a lens in a multi-part cast mold where the combined parts form a topography consistent with the desired final lens. A first mold part can include a convex portion that corresponds with a back curve of an ophthalmic lens and a second mold part can include a concave portion that corresponds with a front curve of the ophthalmic lens.

A typical cast mold process involves depositing a monomer material in a cavity defined between optical surfaces of opposing mold parts. The mold parts are brought together to shape the lens formulation according to desired lens parameters. The lens formulation is cured, for example by exposure to heat and light, thereby forming a lens.

Following cure, the mold parts are separated, a process sometimes referred to as demolding. In some instances, demolding can result in a tear or chip in the formed lens. Typically, the demold process results in the formed lens remaining adhered to one of the mold portions. It is sometimes difficult and time consuming to release the formed lens from the mold part to which the lens has adhered. In particular, some silicone based hydrogel contact lenses are difficult to release in aqueous hydration solutions.

It is desirable therefore to have improved mold materials and processes to facilitate contact lens release, and in some embodiments, lens release in aqueous solutions.

### SUMMARY

Accordingly, the present invention includes improved molds and processes useful in the release of an ophthalmic lens from a plastic mold part used to cast the lens. According a to the present invention, a mold material is used with one or more polyolefins and one or more siloxane waxes. The inclusion of the siloxane wax decreases the surface energy of the mold part as compared to a polyolefin mold part without the siloxane wax.

According to the present invention, a lens forming mixture is cured in a cavity of a desired shape formed by two or more plastic mold parts. At least one of the plastic mold parts is molded from a polyolefin material with siloxane wax or a combination of siloxane waxes which facilitate a lens release from the mold part in hydration, especially in aqueous hydration, as well as reduced lens edge (such as chip and tear) defect.

Embodiments can include at least one of the mold parts being transparent to polymerization initiating radiation such that a polymerizable lens forming mixture can be deposited in the cavity and the mold part and polymerizable composition can be exposed to polymerization initiating radiation.

Embodiments can also include methods of producing an ophthalmic lens by dispensing an uncured lens formulation onto a surface of a mold part including a siloxane wax or combination of mold materials. The ophthalmic lens can include, for example, a silicone hydrogel formulation or a hydrogel formulation. Specific examples can include a lens formed from: acquafilcon A, balafilcon A, and lotrafilcon A, genfilcon A, lenefilcon A, narafilcon A, polymacon and galyfilcon A, and senofilcon A.

### DESCRIPTION OF THE DRAWINGS

FIG. 1 illustrates a mold surface comprising a siloxane wax.

FIG. 2 illustrates a boxplot of surface energy characteristics of mold parts comprising siloxane wax.

FIG. 3 illustrates a boxplot of DI water contact angle characteristics of mold parts comprising siloxane wax.

FIG. 4 illustrates a flow chart of steps that may be used to implement some embodiments of the present invention.

FIG. 5 illustrates a flow chart of additional steps that may be used to implement some embodiments of the present invention

FIG. 6 illustrates chart indicating demold chip and tear defects in mold parts comprising siloxane wax.

FIG. 7 illustrates a mold assembly according to some embodiments of the present invention.

### DETAILED DESCRIPTION OF THE INVENTION

The present invention includes molds and methods for making an ophthalmic lens. According to some embodiments of the present invention, at least one part of a multi-part mold that is used in the manufacture of an ophthalmic lens, is injection molded from a primary thermal plastic resin (hereinafter sometimes referred to as “TPR”) compounded with one or more siloxane waxes, thereby decreasing the surface energy of the mold material and in some embodiments also decreasing the demold force for separating mold parts. In addition, in some embodiments, the siloxane wax increases the contact angle of DI water on the surface of the mold part.

According to the present invention the addition of a siloxane wax to a TPR mold part material that decreases the surface energy of the mold material of one or both of the BC and FC mold parts, facilitates release of a silicone hydrogel lens.

Generally, contact angle is the angle at which a droplet of liquid and a vapor interface meet a solid surface, although a contact angle may also be measured between combinations of liquids and vapors. Contact angle is determined by interactions across interfaces formed. Most often the concept is illustrated with a small liquid droplet resting on a flat horizontal solid surface. The contact angle plays the role of a boundary condition. A contact angle can measured by various methods using a contact angle goniometer.

One method of measuring a contact angle includes the static sessile drop method. The sessile drop method is measured by a contact angle goniometer using an optical subsystem to capture the profile of a pure liquid on a solid substrate. The angle formed between the liquid/solid interface and the liquid-vapor interface is the contact angle. Automated systems employ high resolutions cameras and software to capture and analyze the contact angle. Manual systems can include use of a microscope optical system with a back light.

Dynamic sessile drop methods are similar to the static sessile drop but require the drop to be modified. A common type of dynamic sessile drop study determines the largest contact angle possible without increasing its solid/liquid interfacial area by adding volume dynamically. A maximum angle is the advancing angle. Volume is removed to produce the smallest possible angle, the receding angle. The difference between the advancing and receding angle is the contact angle hysteresis.

Another method of measuring contact angle includes the Dynamic Wilhelmy method wherein average advancing and receding contact angles are calculated on solids of uniform geometry. Wetting force on the solid is measured as the solid is immersed in or withdrawn from a liquid of known surface tension.

Still another method of measuring contact angle includes the Single-fiber Wilhelmy method which applies single fibers to measure advancing and receding contact angles.

Generally, a surface with a contact angle larger than 90° can be considered hydrophobic. A surface with contact angle lower than 90° can be considered hydrophilic. Opthalmic lens mold materials according to the present invention will typically have a contact angle of DI water of over 90°.

In some preferred embodiments, mold parts are fashioned from a thermoplastic polyolefin with a siloxane wax to produce single use cast molds with increased contact angle which reduces the adhesive force between a cured lens and mold parts used to fashion the lens, and is therefore conducive to the manufacture of ophthalmic lenses. Advantages of utilizing molds comprising a thermoplastic polyolefin material with a siloxane wax which results in a higher contact angle include a diminished number of lens defects, such as chips and tears resulting from demold; and also improved release from a mold part in which it is formed. In some preferred embodiments, the release will take place during or after hydration.

In still other embodiments, it has been discovered that a polypropylene mold material can be combined with a siloxane wax provided improved performance in terms of lens release from a mold part fashioned from the compound as compared to a mold part fashioned form one or the other constituents of the compound. Specific embodiments and examples are discussed further below.

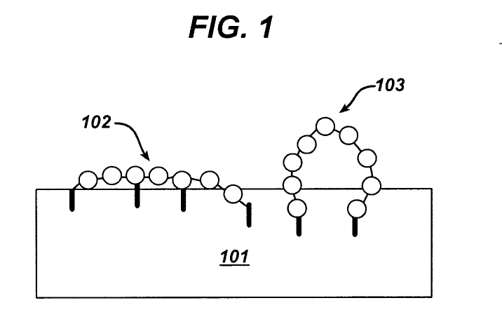

Referring now to FIG. 1, a surface of a TPR with a siloxane wax is illustrated. As illustrated an ABA block copolymer with a relatively high crystalline polyester as the A block and the polydimethyl siloxane (PDMS) as the B block. Such a molecule is very crystalline and even though the B block has a very low rotational energy, it is essentially locked in place and will not change significantly with environmental conditions. During formation, the PDMS block essentially moves away the polymer matrix 101 and results in a mold part 701-702 with a low surface energy.

### Lenses

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision.

As used herein, the term “lens forming mixture” refers to a mixture of materials that can react, or be cured, to form an ophthalmic lens. Such a mixture can include polymerizable components (monomers), additives such as UV blockers and tints, photoinitiators or catalysts, and other additives one might desire in an ophthalmic lens such as a contact or intraocular lens.

In some embodiments, a preferred lens type can include a lens that includes a silicone containing component. A “silicone-containing component” is one that contains at least one [—Si—O—] unit in a monomer, macromer or prepolymer. Preferably, the total Si and attached O are present in the silicone-containing component in an amount greater than about 20 weight percent, and more preferably greater than 30 weight percent of the total molecular weight of the silicone-containing component. Useful silicone-containing components preferably comprise polymerizable functional groups such as acrylate, methacrylate, acrylamide, methacrylamide, vinyl, N-vinyl lactam, N-vinylamide, and styryl functional groups.

Suitable silicone containing components include compounds of Formula I

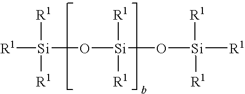

where

R¹ is independently selected from monovalent reactive groups, monovalent alkyl groups, or monovalent aryl groups, any of the foregoing which may further comprise functionality selected from hydroxy, amino, oxa, carboxy, alkyl carboxy, alkoxy, amido, carbamate, carbonate, halogen or combinations thereof; and monovalent siloxane chains comprising 1-100 Si—O repeat units which may further comprise functionality selected from alkyl, hydroxy, amino, oxa, carboxy, alkyl carboxy, alkoxy, amido, carbamate, halogen or combinations thereof;

where b=0 to 500, where it is understood that when b is other than 0, b is a distribution having a mode equal to a stated value;

wherein at least one R¹ comprises a monovalent reactive group, and in some embodiments between one and 3 R¹ comprise monovalent reactive groups.

As used herein “monovalent reactive groups” are groups that can undergo free radical and/or cationic polymerization. Non-limiting examples of free radical reactive groups include (meth)acrylates, styryls, vinyls, vinyl ethers, C₁₋₆alkyl(meth)acrylates, (meth)acrylamides, C₁₋₆alkyl(meth)acrylamides, N-vinyllactams, N-vinylamides, C₂₋₁₂alkenyls, C₂₋₁₂alkenylphenyls, C₂₋₁₂alkenylnaphthyls, C₂₋₆alkenylphenylC₁₋₆alkyls, O-vinylcarbamates and O-vinylcarbonates. Non-limiting examples of cationic reactive groups include vinyl ethers or epoxide groups and mixtures thereof. In one embodiment the free radical reactive groups comprises (meth)acrylate, acryloxy, (meth)acrylamide, and mixtures thereof.

Suitable monovalent alkyl and aryl groups include unsubstituted monovalent C₁ to C₁₆alkyl groups, C₆-C₁₄ aryl groups, such as substituted and unsubstituted methyl, ethyl, propyl, butyl, 2-hydroxypropyl, propoxypropyl, polyethyleneoxypropyl, combinations thereof and the like.

In one embodiment b is zero, one R¹ is a monovalent reactive group, and at least 3 R¹ are selected from monovalent alkyl groups having one to 16 carbon atoms, and in another embodiment from monovalent alkyl groups having one to 6 carbon atoms. Non-limiting examples of silicone components of this embodiment include 2-methyl-,2-hydroxy-3-[3-[1,3,3,3-tetramethyl-1-[(trimethylsilyl)oxy]disiloxanyl]propoxy]propyl ester (“SiGMA”), 2-hydroxy-3-methacryloxypropyloxypropyl-tris(trimethylsiloxy)silane, 3-methacryloxypropyltris(trimethylsiloxy)silane (“TRIS”), 3-methacryloxypropylbis(trimethylsiloxy)methylsilane and 3-methacryloxypropylpentamethyl disiloxane.

In another embodiment, b is 2 to 20, 3 to 15 or in some embodiments 3 to 10; at least one terminal R¹ comprises a monovalent reactive group and the remaining R¹ are selected from monovalent alkyl groups having 1 to 16 carbon atoms, and in another embodiment from monovalent alkyl groups having 1 to 6 carbon atoms. In yet another embodiment, b is 3 to 15, one terminal R¹ comprises a monovalent reactive group, the other terminal R¹ comprises a monovalent alkyl group having 1 to 6 carbon atoms and the remaining R¹ comprise monovalent alkyl group having 1 to 3 carbon atoms. Non-limiting examples of silicone components of this embodiment include (mono-(2-hydroxy-3-methacryloxypropyl)-propyl ether terminated polydimethylsiloxane (400-1000 MW)) (“OH-mPDMS”), monomethacryloxypropyl terminated mono-n-butyl terminated polydimethylsiloxanes (800-1000 MW), (“mPDMS”).

In another embodiment b is 5 to 400 or from 10 to 300, both terminal R¹ comprise monovalent reactive groups and the remaining R¹ are independently selected from monovalent alkyl groups having 1 to 18 carbon atoms which may have ether linkages between carbon atoms and may further comprise halogen.

In one embodiment, where a silicone hydrogel lens is desired, the lens of the present invention will be made from a reactive mixture comprising at least about 20 and preferably between about 20 and 70% wt silicone containing components based on total weight of reactive monomer components from which the polymer is made.

In another embodiment, one to four R¹ comprises a vinyl carbonate or carbamate of the formula:

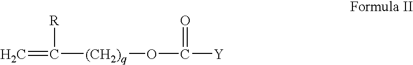

wherein: Y denotes O—, S— or NH—;

R denotes, hydrogen or methyl; d is 1, 2, 3 or 4; and q is 0 or 1.

The silicone-containing vinyl carbonate or vinyl carbamate monomers specifically include: 1,3-bis[4-(vinyloxycarbonyloxy)but-1-yl]tetramethyl-disiloxane; 3-(vinyloxycarbonylthio)propyl-[tris(trimethylsiloxy)silane]; 3-[tris(trimethylsiloxy)silyl]propyl allyl carbamate; 3-[tris(trimethylsiloxy)silyl]propyl vinyl carbamate; trimethylsilylethyl vinyl carbonate; trimethylsilylmethyl vinyl carbonate, and

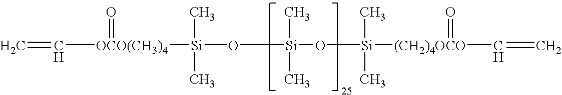

Where biomedical devices with modulus below about 200 are desired, only one R¹ shall comprise a monovalent reactive group and no more than two of the remaining R¹ groups will comprise monovalent siloxane groups.

Another class of silicone-containing components includes polyurethane macromers of the following formulae:

(*D*A*D*G)ₐ*D*D*E¹;

E(*D*G*D*A)ₐ*D*G*D*E¹ or;

E(*D*A*D*G)ₐ*D*A*D*E¹ Formulae IV-VI

wherein:

D denotes an alkyl diradical, an alkyl cycloalkyl diradical, a cycloalkyl diradical, an aryl diradical or an alkylaryl diradical having 6 to 30 carbon atoms,

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

ₐ is at least 1;

A denotes a divalent polymeric radical of formula:

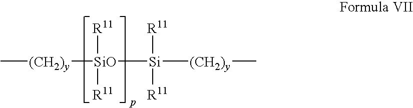

R¹¹ independently denotes an alkyl or fluoro-substituted alkyl group having 1 to 10 carbon atoms which may contain ether linkages between carbon atoms; y is at least 1; and p provides a moiety weight of 400 to 10,000; each of E and E¹ independently denotes a polymerizable unsaturated organic radical represented by formula:

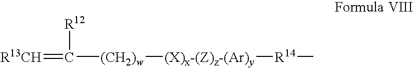

wherein: R¹² is hydrogen or methyl; R¹³ is hydrogen, an alkyl radical having 1 to 6 carbon atoms, or a —CO—Y—R¹⁵ radical wherein Y is —O—,Y—S— or —NH—; R¹⁴ is a divalent radical having 1 to 12 carbon atoms; X denotes —CO— or —OCO—; Z denotes —O— or —NH—; Ar denotes an aromatic radical having 6 to 30 carbon atoms; w is 0 to 6; x is 0 or 1; y is 0 or 1; and z is 0 or 1.

A preferred silicone-containing component is a polyurethane macromer represented by the following formula:

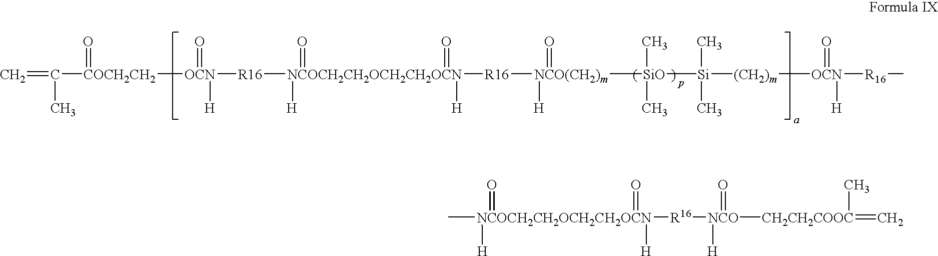

wherein R¹⁶ is a diradical of a diisocyanate after removal of the isocyanate group, such as the diradical of isophorone diisocyanate. Another suitable silicone containing macromer is compound of formula X (in which x+y is a number in the range of 10 to 30) formed by the reaction of fluoroether, hydroxy-terminated polydimethylsiloxane, isophorone diisocyanate and isocyanatoethylmethacrylate.

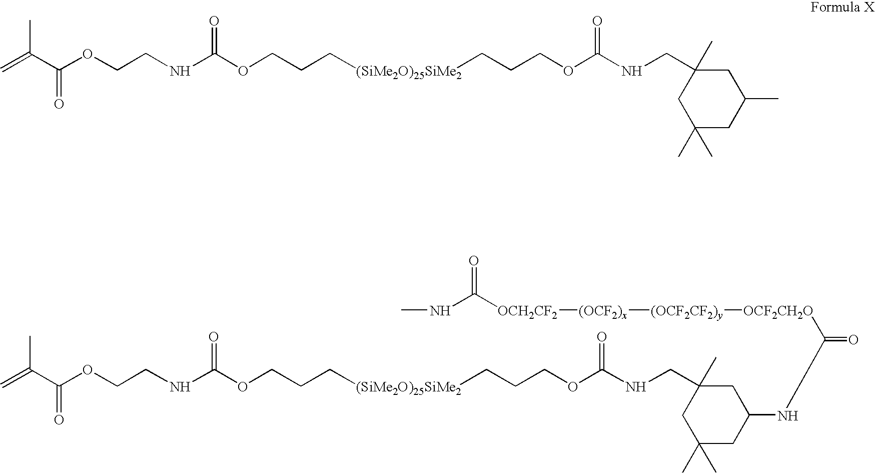

Other silicone containing components suitable for use in this invention include macromers containing polysiloxane, polyalkylene ether, diisocyanate, polyfluorinated hydrocarbon, polyfluorinated ether and polysaccharide groups; polysiloxanes with a polar fluorinated graft or side group having a hydrogen atom attached to a terminal difluoro-substituted carbon atom; hydrophilic siloxanyl methacrylates containing ether and siloxanyl linkanges and crosslinkable monomers containing polyether and polysiloxanyl groups. Any of the foregoing polysiloxanes can also be used as the silicone containing component in this invention.

### Molds

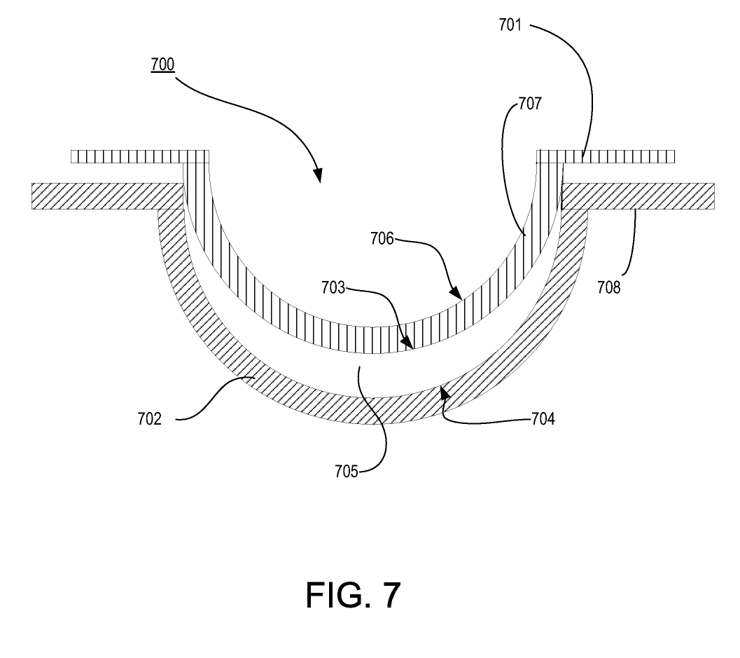

Referring now to FIG. 7, a diagram of an exemplary mold for an ophthalmic lens is illustrated. As used herein, the terms “mold” and “mold assembly” refer to a form 100 having a cavity 705 into which a lens forming mixture can be dispensed such that upon reaction or cure of the lens forming mixture (not illustrated), an ophthalmic lens of a desired shape is produced. The molds and mold assemblies 100 of this invention are made up of more than one “mold parts” or “mold pieces” 701-702. The mold parts 701-702 can be brought together such that a cavity 705 is formed between the mold parts 701-702 in which a lens can be formed. This combination of mold parts 701-702 is preferably temporary. Upon formation of the lens, the mold parts 701-702 can again be separated for removal of the lens.

At least one mold part 701-702 has at least a portion of its surface 703-704 in contact with the lens forming mixture such that upon reaction or cure of the lens forming mixture that surface 703-704 provides a desired shape and form to the portion of the lens with which it is in contact. The same is true of at least one other mold part 701-702.

Thus, for example, in a preferred embodiment a mold assembly 700 is formed from two parts 701-702, a female concave piece (front piece) 702 and a male convex piece (back piece) 701 with a cavity formed between them. The portion of the concave surface 704 which makes contact with lens forming mixture has the curvature of the front curve of an ophthalmic lens to be produced in the mold assembly 700 and is sufficiently smooth and formed such that the surface of a ophthalmic lens formed by polymerization of the lens forming mixture which is in contact with the concave surface 704 is optically acceptable.

In some embodiments, the front mold piece 702 can also have an annular flange integral with and surrounding circular circumferential edge 708 and extends from it in a plane normal to the axis and extending from the flange (not shown).

The back mold piece 701 has a central curved section with a concave surface 706, convex surface 703 and circular circumferential edge 707, wherein the portion of the convex surface 703 in contact with the lens forming mixture has the curvature of the back curve of a ophthalmic lens to be produced in the mold assembly 700 and is sufficiently smooth and formed such that the surface of a ophthalmic lens formed by reaction or cure of the lens forming mixture in contact with the back surface 703 is optically acceptable. Accordingly, the inner concave surface 704 of the front mold half 702 defines the outer surface of the ophthalmic lens, while the outer convex surface 703 of the base mold half 701 defines the inner surface of the ophthalmic lens.

In some preferred embodiments, molds 700 can include two mold parts 701-702 as described above, wherein one or both of the front curve part 702 and the back curve part 701 of the mold 700 comprises a thermoplastic polyolefin compound and a siloxane wax compounded with the polyolefin.

Blended mold material resins can be obtained, for example, using different compounding methods, including hand blending, single screw compounding, twin screw and/or multiple screw compounding.

Some embodiments include a mold part with a lower surface energy (as low as 19 mN/m) or more silicone rich mold material can be possibly achieved by compounding Zeonor 1060R with up to 10% Siloxane Wax.

Some particular embodiments include siloxane wax containing a molecular structure, including: (CH₃)₃SiO—[CH₃SiR]_{X}—Si(CH₃)₃, where R is combination of CH3 and a distribution of alkyl groups from C18-C60. X is between 20 and 100. One such material is supplied by Trillium Specialties under the laboratory notebook material codes of 1006-83 and 1006-70. Even though 1006-83 has the same molecular structure as 1006-70, 1006-83 has the lower molecular weight and lower melting point. Additionally, the ratio of organic content to siloxane is lower in the 1006-83 which makes it slightly less compatible with the Zeonor 1060R and slightly more surface active than the 1006-70.

Another example of siloxane wax could be an ABA block copolymer with a highly crystalline polyester as the A block and the polydimethyl siloxane as the B block. This material under laboratory notebook material code of 1006-83 is also supplied by Trillium Specialties.

Preferred embodiments can also include a polyolefin of one or more of: polypropylene, polystyrene, polyethylene, polymethyl methacrylate, and modified polyolefins.

Thermoplastics that can be compounded with a siloxane wax can include, for example, one or more of: polypropylene, polystyrene and alicyclic polymers.

In some embodiments the thermoplastic resin can include an alicyclic polymer which refers to compounds having at least one saturated carbocyclic ring therein. The saturated carbocyclic rings may be substituted with one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents are selected from one or more members of the group consisting of halogen, hydroxyl, C₁₋₁₀alkoxycarbonyl, C₁₋₁₀alkoxy, cyano, amido, imido, and silyl. Examples of alicyclic polymers include but are not limited to polymerizable cyclobutanes, cyclopentanes, cyclohexanes, cycloheptanes, cyclooctanes, biscyclobutanes, biscyclopentanes, biscyclohexanes, biscycloheptanes, biscyclooctanes, and norbornanes. It is preferred that the at least two alicyclic polymers be polymerized by ring opening metathesis followed by hydrogenation. Since co-polymers are costly, it is preferable that the molds made from these co-polymers may be used several times to prepare lenses instead of once which is typical. For the preferred molds of the invention, they may be used more than once to produce lenses.

More particularly, examples of alicyclic polymer containing saturated carbocyclic rings include but are not limited to the following structures:

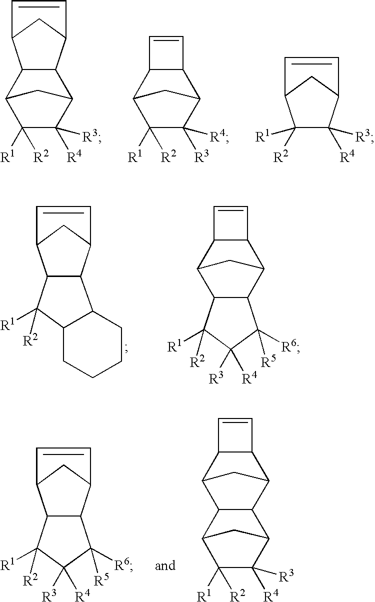

wherein R¹⁻⁶ are independently selected from one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents selected from one or more members of the group consisting of halogen, hydroxyl, C₁₋₁₀alkoxycarbonyl, C₁₋₁₀alkoxy, cyano, amido, imido and silyl. Further two or more of R¹⁻⁶ may be taken together to form an unsaturated bond, a carbocyclic ring, a carbocyclic ring containing one or more unsaturated bonds, or an aromatic ring. The preferred R¹⁻⁶ is selected from the group consisting of C₁₋₁₀alkyl and substituted C₁₋₁₀alkyl where the substituents are selected from the group consisting of halogen, hydroxyl, C₁₋₁₀alkoxycarbonyl, C₁₋₁₀alkoxy, cyano, amido, imido and silyl.

The alicyclic co-polymers consist of at least two different alicyclic polymers. The preferred alicyclic co-polymers contain two or three different alicyclic polymers, selected from the group consisting of:

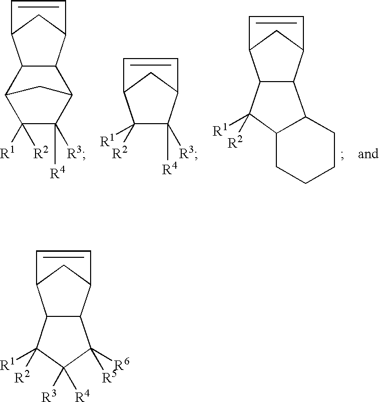

The particularly preferred alicyclic co-polymer contains two different alicyclic momoners where the generic structure of the saturated carbocyclic rings of the alicyclic polymers are of the formula

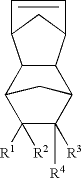

and R¹-R⁴ are C₁₋₁₀alkyl.

A preferred alicyclic co-polymer contains two different alicyclic polymers and is sold by Zeon Chemicals L.P. under the trade name ZEONOR and ZEONEX. There are several different grades of ZEONOR and ZEONEX. Various grades may have glass transition temperatures ranging from 100° C. to 160° C. A specifically preferred material is ZEONOR 1060R.

Other mold materials that may combined with one or more additives to form an ophthalmic lens mold include, for example, Zieglar-Natta polypropylene resins (sometimes referred to as znPP). On exemplary Zieglar-Natta polypropylene resin is available under the name PP 9544 MED. PP 9544 MED is a clarified random copolymer for clean molding as per FDA regulation 21 CFR (c)3.2 made available by ExxonMobile Chemical Company. PP 9544 MED is a random copolymer (znPP) with ethylene group (hereinafter 9544 MED). Other exemplary Zieglar-Natta polypropylene resins include: Atofina Polypropylene 3761 and Atofina Polypropylene 3620WZ.

Still further, in some embodiments, the molds of the invention may contain polymers such as polypropylene, polyethylene, polystyrene, polymethyl methacrylate, modified polyolefins containing an alicyclic moiety in the main chain and cyclic polyolefins. This blend can be used on either or both mold halves, where it is preferred that this blend is used on the back curve and the front curve consists of the alicyclic co-polymers.

In some preferred methods of making molds 100 according to the present invention, injection molding is utilized according to known techniques, however, embodiments can also include molds fashioned by other techniques including, for example: lathing, diamond turning, or laser cutting.

Typically, lenses are formed on at least one surface of both mold parts 701-702. However, if need be one surface of the lenses may be formed from a mold part 701-702 and the other lens surface can be formed using a lathing method, or other methods.

As used herein “lens forming surface” means a surface 703-704 that is used to mold a lens. In some embodiments, any such surface 703-704 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 703-704 can have a geometry that is necessary to impart to the lens surface the desired optical characteristics, including without limitation, spherical, aspherical and cylinder power, wave front aberration correction, corneal topography correction and the like as well as any combinations thereof

### Methods

The following method steps are provided as examples of processes that may be implemented according to some aspects of the present invention. It should be understood that the order in which the method steps are presented is not meant to be limiting and other orders may be used to implement the invention. In addition, not all of the steps are required to implement the present invention and additional steps may be included in various embodiments of the present invention.

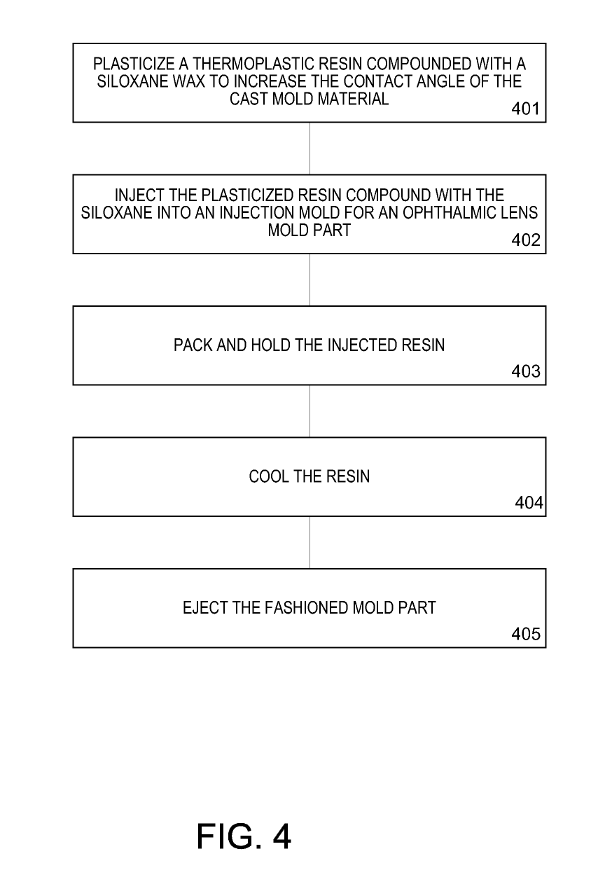

Referring now to FIG. 4, a flowchart illustrates exemplary steps that may be used to implement the present invention. At 401, a first TPR compounded with a siloxane wax to increase water contact angle is plasticized and prepared for use in an injection molding process. Injection molding techniques are well known and preparation typically involves heating resin pellets beyond a melting point.

At 402, the plasticized resin is injected into an injection mold shaped in a fashion suitable for creating an ophthalmic lens mold part 701-702. At 203, the injection mold is typically placed in a pack and hold status for an appropriate amount of time, which can depend, for example upon the resin utilized and the shape and size of the mold part. At 204, the formed mold part 701-702 is allowed to cool and at 405, the mold part 701-702 can be ejected, or otherwise removed from the injection mold.

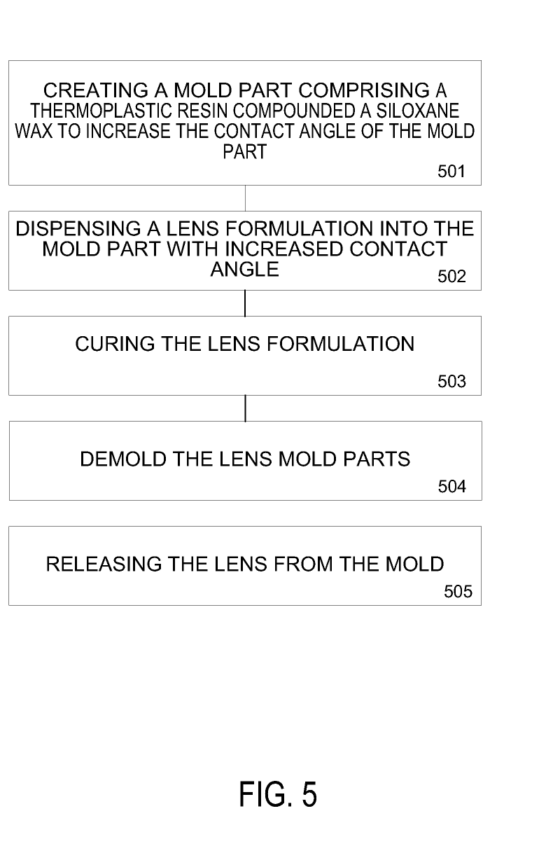

Referring now to FIG. 5, some embodiments of the present invention include methods of making an ophthalmic lens comprising, consisting essentially of, or consisting of the following steps. At 501 one or more mold parts 701-702 are created which comprise, consist essentially of, or consist of, including a TPR compounded with a siloxane wax for reducing the surface energy of the TPE or increasing the contact angle of the TPR. At 502, an uncured lens formulation is dispensed onto the one or more mold parts 701-702 and at 503, the lens formulation is cured under suitable conditions. At 504 following formation, a demolding step may be implemented. Additional steps can include, for example, hydrating a cured lens until it releases from a mold part 701-702 and leaching acute ocular discomfort agents from the lens. At 505 the lens may be released from the mold part.

As used herein, the term “uncured” refers to the physical state of a lens formulation prior to final curing of the lens formulation to make the lens. In some embodiments, lens formulations can contain mixtures of monomers which are cured only once. Other embodiments can include partially cured lens formulations that contain monomers, partially cured monomers, macromers and other components.

As used herein, the phrase “curing under suitable conditions” refers to any suitable method of curing lens formulations, such as using light, heat, and the appropriate catalysts to produce a cured lens. Light can include, in some specific examples, ultra violet light. Curing can include any exposure of the lens forming mixture to an actinic radiation sufficient to case the lens forming mixture to polymerize.

### EXAMPLES

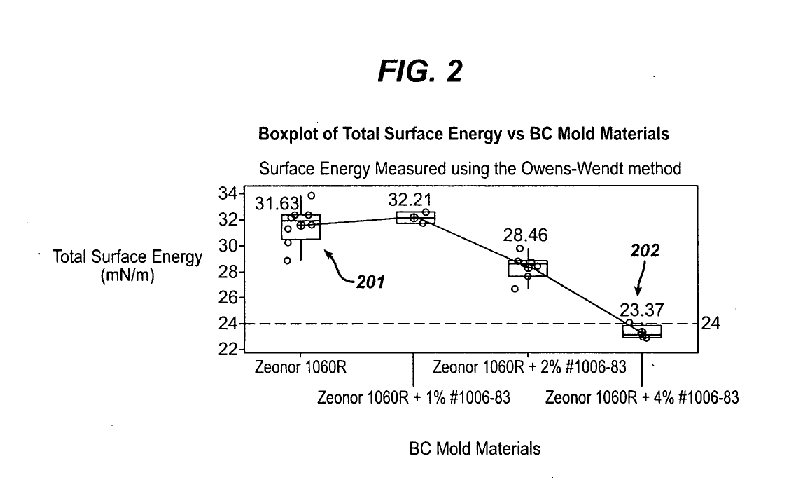

Referring now to FIG. 2, a box diagram illustrates how the inclusion of a siloxane wax in a polyolefin materials, such as Zeonor 1060R can result in a lower surface energy. The Zeonor 1060R without a siloxane wax 201 has a box plot of about 31.63 nM as measured with the Owens Wendt method. The Zeonor 1060R with a siloxane wax 202 of about 4% 1006-83 has a box plot of about 23.37 mN/m as measured with the Owens Wendt method.

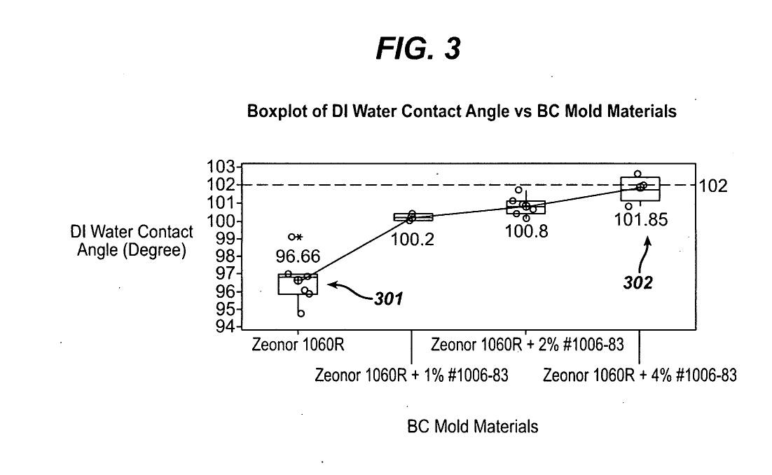

Referring now to FIG. 3, a box diagram illustrates how the inclusion of a siloxane wax in a polyolefin materials, such as Zeonor 1060R, can result in a higher surface energy. The Zeonor 1060R without a siloxane wax 301 has a box plot of about 96.66 degree of DI water contact angle. The Zeonor 1060R with a siloxane wax 302 of about 4% 1006-83 has a box plot of about 101.85 degrees of DI water contact angle.

A silicone rich and lower BC mold surface energy ˜23 mN/m is achieved by compounding Zeonor 1060R with 4% 1006-83. The BC mold surface energy is measured using a DSA device, such as by way of example, one manufactured by KRÜSS. Increased concentration of siloxane wax blended with Zeonor impacts measured mold surface energy. In particular, compounding 4% 1006-83 with Zeonor dramatically lowers Zeonor BC mold surface energy from average 31.63 mN/m to average 23.37 mN/m. Surface energy of pure silicone can fluctuate between 22-25 mN/m. This data shown in the graph below suggests that we are getting dramatic self-assembly of the silicone blocks at the surface of the mold/air interface.

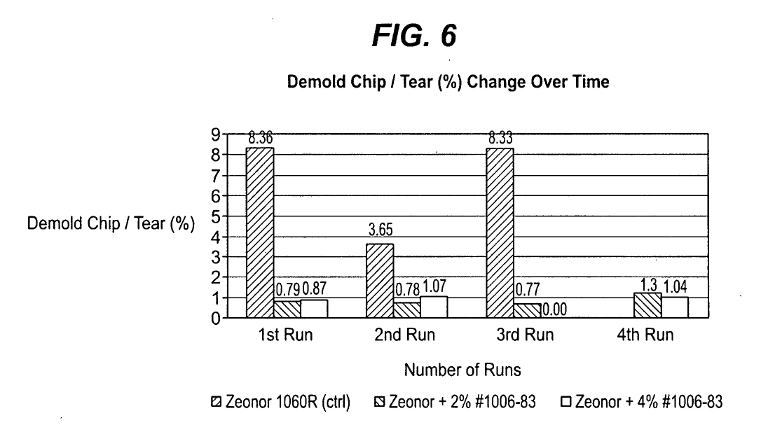

Referring now to FIG. 6, a chart illustrates a decrease in lens edge defect or an increase in manufacturing efficiency.

### CONCLUSION

The present invention, as described above and as further defined by the claims below, provides mold parts 701-702 fashioned from a thermal plastic resin compounded with another thermal plastic resin or with a siloxane wax to increase a DI water contact angle or decrease of surface energy of the mold part, improve release performance of an ophthalmic lens formed therein, and an ophthalmic lens formed in the mold part.

What is claimed is:

1. An improved method of molding an ophthalmic lens, wherein a lens forming mixture is cured in a cavity of a desired shape formed by two or more mold parts;
the improvement comprising curing the lens forming mixture in a cavity formed with at least one mold part comprising a thermal plastic resin compounded with a siloxane wax resulting in a surface with a deionized water contact angle that is greater than the deionized water contact angle of the thermal plastic resin.

2. The method of claim 1, wherein a first mold part, comprises a concave surface, a second mold part, comprises a convex surface, and at least the second mold part comprises the thermal plastic compound comprising a siloxane wax with a deionized water contact angle that is greater than the deionized water contact angle of the thermal plastic resin.

3. The method of claim 2 wherein at least one of the mold parts is at least partially transparent to polymerization initiating radiation and the cavity comprises the shape and size of an ophthalmic lens, the method additionally comprising the steps of:
depositing lens forming mixture comprising a polymerizable composition in the cavity;
exposing the mold parts and the polymerizable composition to polymerization initiating radiation to form an ophthalmic lens; and
exposing the ophthalmic lens to an aqueous hydration solution until the ophthalmic lens is released from one of the mold parts.

4. The method of claim 3 additionally comprising the step of:
decreasing the time in which the ophthalmic lens is exposed to the aqueous hydration solution until the ophthalmic lens is released as compared to a mold part comprising the thermoplastic resin without the siloxane wax.

5. The method of claim 4, wherein the deionized water contact angle of a mold part comprising the first thermal plastic resin without the second thermal plastic resin or siloxane wax is less than 100° and increases to greater than 100° when compounded with the siloxane wax.

6. The method of claim 4 wherein the siloxane wax comprises an ABA block copolymer.

7. The method of claim 6 wherein the B block comprises polydimethyl siloxane.

8. An improved method of molding an ophthalmic lens, wherein a lens forming mixture is cured in a cavity of a desired shape formed by two or more mold parts;
the improvement comprising curing the lens forming mixture in a cavity formed with at least one mold part comprising a first thermal plastic resin with siloxane wax, wherein the addition of the siloxane wax results in a thermal plastic compound with a surface energy that is less than the surface energy of a mold part comprising the thermal plastic resin without the additive.

9. The method of claim 8 wherein the siloxane wax comprises an ABA block copolymer.

10. The method of claim 6 wherein the B block comprises polydimethyl siloxane.

11. The mold of claim 10 wherein at least one of the first thermoplastic resin and the second plastic resin comprises polypropylene.

12. The mold of claim 10 wherein at least one of the first thermoplastic resin and the second plastic resin comprises an alicyclic co-polymer or alicyclic polymer.

13. The mold of claim 12 wherein the at least one of the first mold part and the second mold part comprising a first thermal plastic resin compounded with a siloxane wax comprises about 55% wt alicyclic co-polymer or alicyclic polymer and 45% wt Zieglar natta polypropylene.

14. The mold of claim 12 wherein the at least one of the first mold part and the second mold part comprising a first thermal plastic resin compounded with a siloxane wax comprises about 75% wt alicyclic co-polymer, or alicyclic polymer and 25% wt Zieglar natta polypropylene.

15. The mold of claim 12 wherein the first thermal plastic resin compounded with a siloxane wax comprises a melt flow rate less than about 21 g/10 minutes.

16. An ophthalmic lens produced by a method comprising the steps of:
dispensing an uncured lens formulation into a first mold part;
positioning a second mold part relative to the first mold part to form a cavity containing the lens formulation in a shape and size suitable to form an ophthalmic lens;
wherein at least one of the first mold part and the second mold part comprises a first thermal plastic resin compounded with a siloxane wax resulting in a thermal plastic compound with a deionized water contact angle that is greater than the deionized water contact angle of the first thermal plastic resin; and
curing said lens formulation under actinic conditions suitable to the uncured lens formulation.

17. The ophthalmic lens of claim 16 wherein the uncured lens formulation comprises a silicone hydrogel formulation.

18. The lens of claim 17 wherein the uncured lens formulation comprises at least one of: etafilcon A, genfilcon A, lenefilcon A, narafilcon A, polymacon and galyfilcon A, and senofilcon A.
